(19) United States
(12) Patent Application Publication
(10) Pub. No.: US 2010/0295422 A1
(43) Pub. Date: Nov. 25, 2010

(54) Stacking alternator

(76) Inventor: Chester Sohn, Gig Harbor, WA (US)

Correspondence Address: DAVID AND RAYMOND PATENT FIRM, 108 N. YNEZ AVE., SUITE 128, MONTEREY PARK, CA, 91754, US

(21) Appl. No.: 12/454,614

(22) Filed: May 19, 2009

(51) Int. Cl. H02K 21/24; H02K 5/00; H02K 3/28; H02K 11/04

(52) U.S. Cl. 310/68 D; 310/91; 310/208; 310/156.12

(57) ABSTRACT

A stacking alternator includes a supporting frame, at least one stationary armature device securely supported by the supporting frame and at least two rotating magnetic devices rotatably supported by the supporting frame two sides of the stationary armature device respectively, wherein the rotating magnetic devices are arranged to be driven to move with respective to the stationary armature device so as to produce a relative movement between the stationary armature device and the rotating magnetic devices for generating a predetermined amount of electrical current at the stationary armature device, wherein the stationary armature device and the rotating magnetic devices are alignedly and spacedly supported by the supporting frame to form a stacking structure of the stationary armature device and the rotating magnetic devices.

### BACKGROUND OF THE PRESENT INVENTION

1. Field of Invention

The present invention relates to an alternator, and more particularly to a stacking alternator which comprises layers of rotating magnetic devices and stationary armature devices rigidly supported in stack for generating a relatively large amount of electrical current with a relatively compact size for the stacking alternator.

2. Description of Related Arts

A conventional alternator is an electromechanical device using a rotating magnetic field that converts mechanical energy to alternating current and electrical energy.

A conventional power generator typically comprises a conductor and a rotating electric magnet. When the magnetic field in the vicinity of a conductor changes, a current is induced in that conductor. Conventionally, the rotating magnet turns within a stationary set of conductors wound in coils on an iron core, called stator. The magnetic field cuts across the conductors and generates an electrical current. The rotor magnetic field may be produced by induction, by permanent magnets in very small machines, or by a rotor winding energized with electrical current through slip rings and brushes.

There are several disadvantages in relation to the above-mentioned conventional alternators. First, conventional alternators do not have an easy way to change power output thereof. In particular, when a large power output is required, the number or the size of the rotor or the stator must be increased. Ultimately, the overall size of the power generator must be increased too. Yet in most industrial environments, an alternator of a larger size may not be desirable or even infeasible. However, the conventional alternator is limited to preset RPM for frequency control and full output of power.

Second, since the induced e.m.f. of a particular alternator or an AC generator is a function of flux density and the total area of the armature coil involved, in order to achieve a greater induced e.m.f., the area of the armature coil involved must also be increased.

Third, conventional alternators usually comprise a plurality of graphite blocks or brushes for electrically connecting the induced e.m.f. to an external circuit so as to make use of the generated AC power. However, the structural designs of the brushes are usually, for example, to make the alternators not durable easy to have problems when the alternators have been used for a prolonged period of time.

Finally, conventional alternators are well-known to also suffer from such disadvantages as having unsatisfactory efficiency and effectiveness.

### SUMMARY OF THE PRESENT INVENTION

A main object of the present invention is to provide a stacking alternator which comprises a plurality of layers of stationary armature devices and rotating magnetic devices supported in stack for generating a relatively large amount of electrical current with a relatively compact size.

Another object of the present invention is to provide a stacking alternator which does not involve the use of brushes so as to overcome the traditional problem associated with the presence of brushes in a typical alternator. As a result, the speed of rotation on the part of the rotating magnetic devices can be substantially increased (enabling a higher safe speed of rotation), so as to substantially increase the effectiveness and efficiency of the performance of the stacking alternator as compared with conventional alternators.

Another object of the present invention is to provide a stacking alternator comprising a plurality of layers of stationary armature devices and rotating magnetic devices supported in stack, which can be selectively and conveniently assembled and disassembled for allowing the stacking alternator to be utilized in a wide variety of circumstances depending on specific needs. In other words, when different power supplies are required, users of the present invention may simply utilize the corresponding number of stationary armature devices and rotating magnetic devices without substantially altering the structure of the alternator. For example, higher power output can be achieved by making the stacking alternator longer without changing its diameter size.

Another object of the present invention is to provide a stacking alternator which is capable of being connected with a wide range of power devices, such as a wind or a water turbine, for effectively and efficiently convert energy of one form into electrical power.

Accordingly, in order to accomplish the above objects, the present invention provides a stacking alternator, comprising:

a supporting frame;

at least one stationary armature device securely supported by the supporting frame; and

at least two rotating magnetic devices rotatably supported by the supporting frame and positioned at two sides of the stationary armature device respectively in such a manner that each stationary armature device is sandwiched between two rotating magnetic devices, wherein the rotating magnetic devices are arranged to be driven to move with respective to the stationary armature device so as to produce a relative movement between the stationary armature device and the rotating magnetic devices for generating a predetermined amount of electrical current at the stationary armature device, wherein the stationary armature device and the rotating magnetic devices are alignedly and spacedly supported by the supporting frame to form a stacking structure of the stationary armature device and the rotating magnetic devices.

Moreover, the present invention also provides a method of generating electricity, comprising the steps of:

(a) providing at least one stationary armature device, at least two rotating magnetic devices and a supporting frame, wherein the stationary armature device is securely and spacedly supported by the supporting frame, and the rotating magnetic devices are rotatably supported by the supporting frame at two sides of the stationary armature device respectively in such a manner that each stationary armature device is sandwiched between two rotating magnetic devices;

(b) driving the rotating magnetic devices to rotate with respective to the stationary armature device so as to produce a relative movement between the stationary armature device and the rotating magnetic devices for generating a predetermined amount of electrical current at the stationary armature device, wherein the stationary armature device and the rotating magnetic devices are alignedly and spacedly supported by the supporting frame to form a stacking structure of the stationary armature device and the rotating magnetic devices; and

(c) processing the electrical current outputted from the stationary armature device by an electrical rectifier for further electrical usages.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a stacking alternator according to a preferred embodiment of the present invention.

FIG. 2 is an exploded perspective of the entire stacking alternator according to the above preferred embodiment of the present invention.

FIG. 3A and FIG. 3C are schematic diagrams of the stationary armature device of the stacking alternator according to the above preferred embodiment of the present invention.

FIG. 4 is a perspective view of the rotating magnetic device of the stacking alternator according to the above preferred embodiment of the present invention.

FIG. 5 illustrates a method of generating electricity by the stacking alternator according to the above preferred embodiment of the present invention.

### DETAILED DESCRIPTION OF THE PREFERRED EMBODIMENT

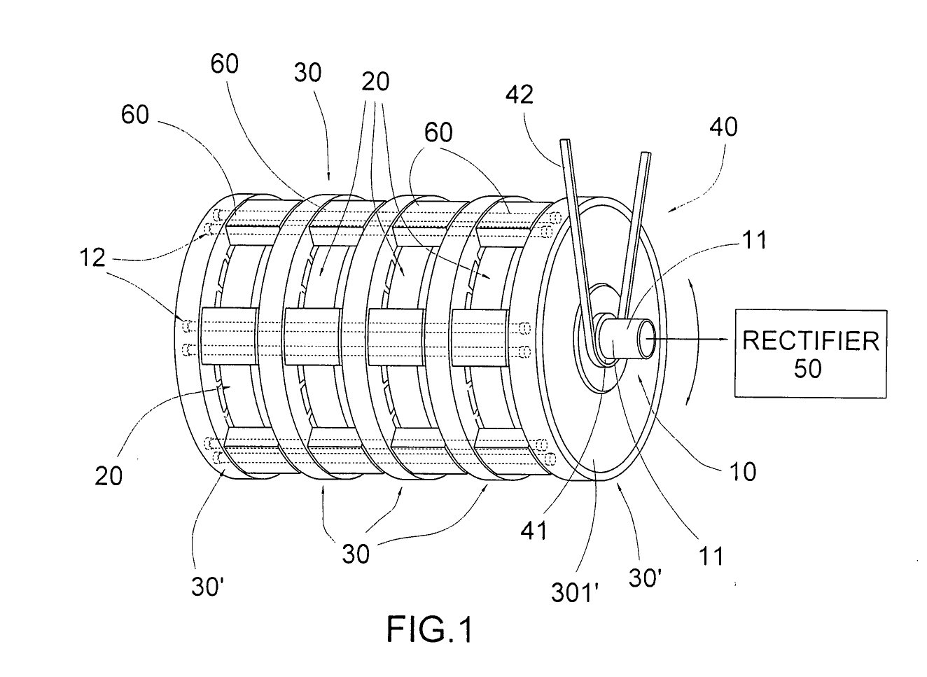

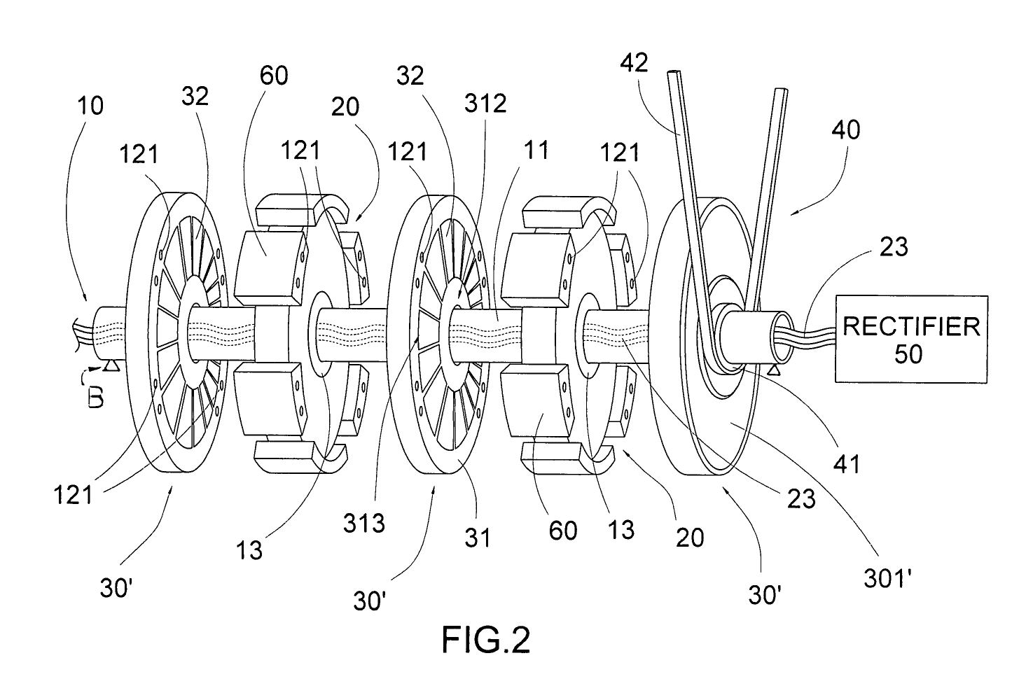

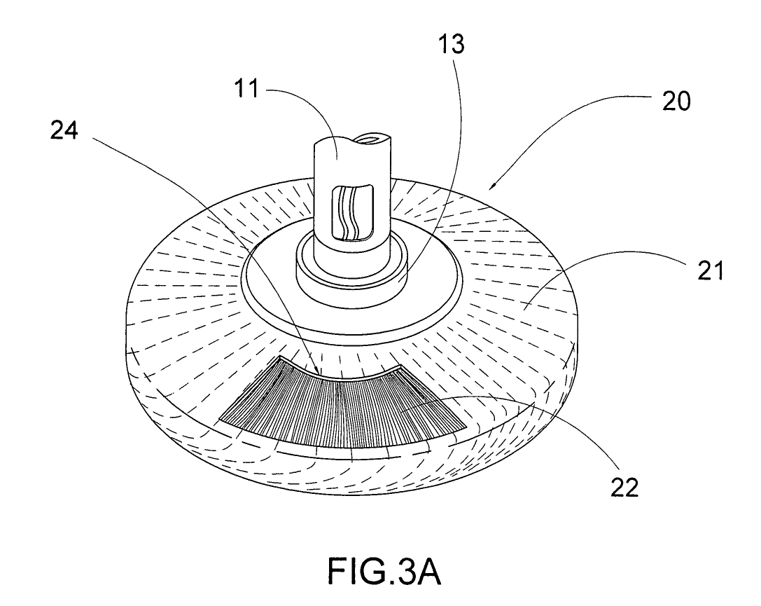

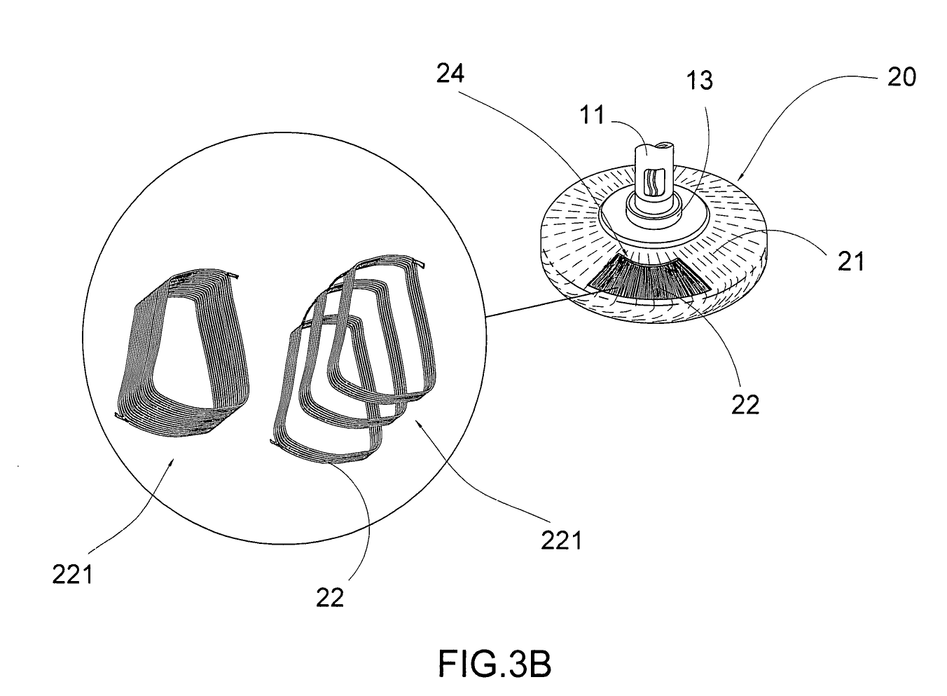

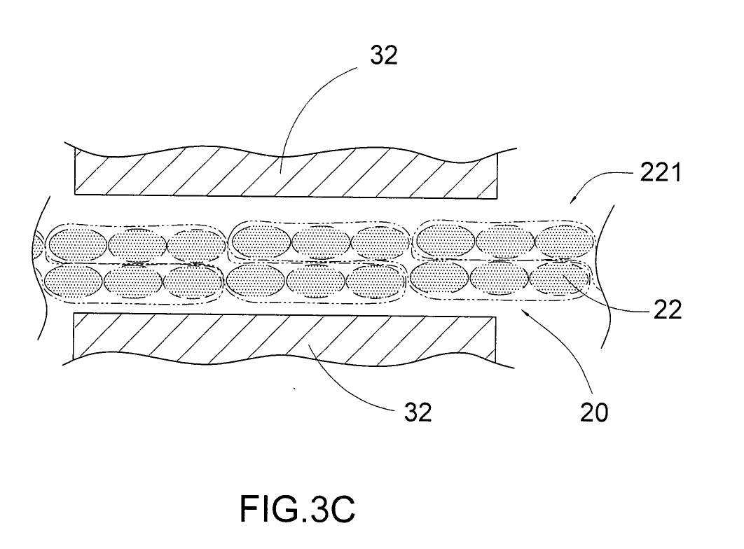

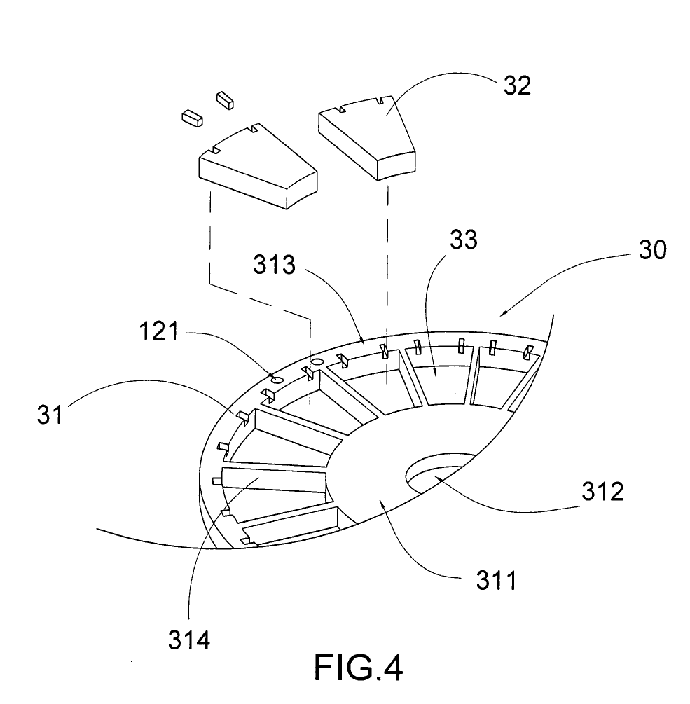

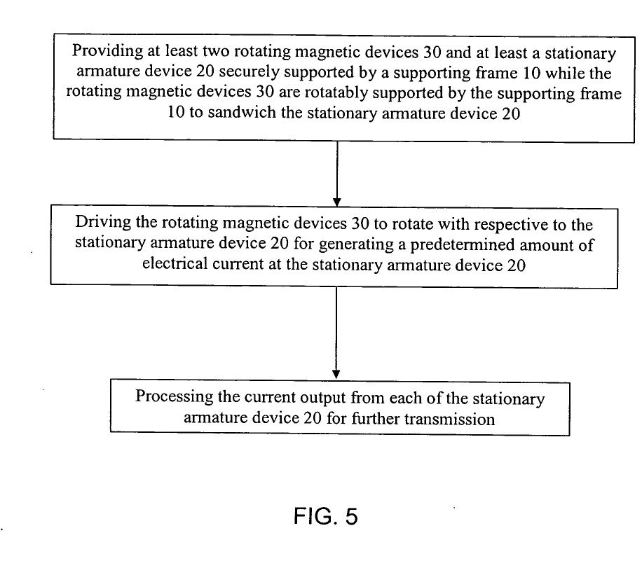

Referring to FIG. 1 to FIG. 2, FIG. 3A to FIG. 3C, FIG. 4 and FIG. 5 of the drawings, a stacking alternator according to a preferred embodiment of the present invention is illustrated, in which the stacking alternator comprises a supporting frame 10, at least one stationary armature device 20 and at least two rotating magnetic devices 30.

Although one stationary armature device 20 sandwiched between two rotating magnetic devices 30 to form a stacking structure can construct the stacking alternator of the present invention, for better performance, the stacking alternator according to the preferred embodiment of the present invention comprises a plurality of stationary armature devices 20 and a plurality of rotating magnetic devices 30 mounted in a stacking structure. In which, each of the two rotating magnetic devices 30′ positioned at two outermost ends of the stacking alternator has a cover surface 301′ provided at the outer side of the rotating magnetic device 30′ for covering the magnets 32 therein to form two end pieces of the stacking alternator.

Each of the stationary armature devices 20 is securely and spacedly supported by the supporting frame 10 while two of the rotating magnetic devices 30 are positioned at two sides of the stationary armature device 20 respectively and rotatably supported at a position spaced apart from the stationary armature device 20. In other words, each of the stationary armature devices 20 is supported by the supporting frame 10 and sandwiched between two of the rotating magnetic devices 30.

The rotating magnetic devices 30 are arranged to be driven to rotate with respective to the corresponding stationary armature device 20 so as to produce a relative movement between the stationary armature devices 20 and the rotating magnetic devices 30 for generating a predetermined amount of electrical current at the stationary armature devices 20.

The stacking alternator of the present invention can be installed in power plant such as windmill, turbine and wind turbine or acting as an electric generator, by, for example, supporting the supporting frame 10 with a base or stand B, as illustrated in FIG. 2.

According to the preferred embodiment of the present invention, the supporting frame 10 comprises a supporting shaft 11, a plurality of securing bars 12 and a plurality of spacers 60 made of non-conducting material such as aluminum. The stationary armature devices 20 and the rotating magnetic devices 30 are mounted to the supporting shaft 11, wherein the stationary armature devices 20 are rotatably mounted to the supporting shaft 11 by a bearing unit 13 such that each of the stationary armature devices 20 is supported in a stationary position while the supporting shaft 11 is rotating. The rotating magnetic devices 30 are securely mounted to the supporting shaft 11 such that the rotating magnetic devices 30 are capable of being driven to rotate with the supporting shaft 11 for inducing the stationary armature devices 20 to generate electricity current, as shown in FIGS. 2 and 3A.

Each of the stationary armature devices 20, positioned between two of the rotating magnetic devices 30, is surrounded without contacting with a plurality of the spacers 60. As shown in FIG. 1, the rotating magnetic devices 30 and the spacers 60 are connected together to form an one body structure by means of the plurality of securing bars 12 which are penetrated through a plurality of securing holes 121 longitudinally provided in the boundary edges of the rotating magnetic devices 30 and the spacers 60. Accordingly, the supporting shaft 11, the rotating magnetic devices 30 and the spacers 60 are integrally connected together to form a rotating structure that can be driven to rotate simultaneously while each of the stationary armature devices 20 is sandwiched between two of the rotating magnetic devices 30 and remains stationary.

Referring to FIG. 3A, each of the stationary armature devices 20 comprises a plurality of armature coils 22 wound and arranged in a predetermined manner such that when a relative movement between the stationary armature device 20 and the rotating magnetic device 30 is produced, e.m.f. will be induced at the armature coils 22.

On the other hand, referring to FIG. 4, each of the rotating magnetic devices 30 comprises a rotor frame 31 and the plurality of magnetic members 32 spacedly provided in the rotor frame 31 for providing a predetermined magnetic field for the corresponding stationary armature devices 20. The magnetic members 32 are preferably permanent magnetic members, such as permanent magnets, and each has a size slightly smaller than the respective armature coil 22. More specifically, the rotor frame 31, which has a substantially circular cross section, has a plurality of receiving slots 33 spacedly provided therein, wherein the magnetic members 32 are securely and rigidly mounted in the receiving slots 33 respectively to form an integral body with the rotor frame 31 for proving the magnetic field to generate the electrical current at the stationary armature devices 20. As shown in FIGS. 1, 2 and 4, each magnetic member 32 is rigidly affixed in the respective receiving slot 33 and the two sides of each magnetic member 32 of each rotating magnetic device 30 face two adjacent stationary armature devices 20 coaxially stacked at two sides of the rotating magnetic device 30 respectively.

As shown in FIG. 4 of the drawings, the rotor frame 31 is preferably has a central portion 311 having a central rotor slot 312 formed therein, an outer peripheral rim portion 313, and a plurality of connecting members 314 radially and spacedly extended from the central portion 311 to the outer peripheral rim portion 313 along a circumferential length thereof to define a corresponding number (e.g. eighteen) of the receiving slots 33 between each two connecting members 314. The supporting shaft 11 of the supporting frame 10 is arranged to be securely inserted and engaged with the rotor slot 312 for producing the relative movement between the rotating magnetic device 30 and stationary armature device 20. The outer peripheral rim portion 313 of the rotor frame 31 is provided with the securing holes 121 as described above.

According to the preferred embodiment of the present invention, the relative movements between the rotating magnetic devices 30 and the stationary armature devices 20 are accomplished by rotatably driving the rotating magnetic devices 30 to move with respective to the corresponding stationary armature devices 20. In other words, the rotor frame 31 is arranged to be driven to rotate with respective to the corresponding stationary armature devices 20 so that electromagnetic induction is arranged to take place at the corresponding stationary armature devices 20 (i.e. at the corresponding armature coils 22).

It is worth mentioning that the stacking alternator can comprise as many rotating magnetic devices 30 and stationary armature devices 20 as the circumstance requires to generate an optimal amount of electrical energy, wherein each stationary armature device 20 and two rotating magnetic devices 30 are supported by the supporting frame 10 in the manner described above. In other words, the stacking alternator comprises a plurality of rotating magnetic devices 30 and a plurality of stationary armature devices 20 operatively supported by said supporting frame 10, wherein each of said stationary armature devices 20 is arranged to be supported between two rotating rotating magnetic devices 30 so that when the rotating magnetic devices 30 are driven to rotate, e.m.f. will be induced at the corresponding stationary armature devices 20.

The structure of the present invention would ensure that each of the stationary armature devices 20 is sandwiched by two of the rotating magnetic devices 30 so that when the rotating magnetic devices 30 are driven to rotate, the stationary armature devices 20 are induced with electrical current. The electrical current induced at each of the stationary armature devices 20 is then collected for generating an overall electrical current of the stacking alternator. According to the innovative construction of the present invention as described above, the stationary armature devices 20 are each at the same time forming a common stationary armature device 20 for two adjacent rotating magnetic devices 30 so that the induced current at that particular stationary armature devices 20 is a result of the rotation of two adjacent rotating magnetic devices 30. In other words, for a stacking alternator having a plurality of stationary armature devices 20 and a plurality of rotating magnetic devices 30, each of the stationary armature devices 20 is sandwiched between two rotatable rotating magnetic devices 30 for generating electricity.

It is also worth mentioning that each of the rotating magnetic devices 30 is preferably driven to rotate simultaneously by a driving force so that the electrical current induced at the stationary armature devices 20 can be uniformly collected. According to the preferred embodiment of the present invention, the stacking alternator further comprises a pulley system 40 attaching to one or more predetermined rotating magnetic devices 30 for mechanically connecting with an external power source device, such as a steam engine or a wind turbine. Accordingly, mechanical energy (as produced by the external power source device) will be effectively converted into electrical energy by the stacking alternator of the present invention. The pulley system 40 is preferably embodied to comprise a pulley 41 and a belt assembly 42 for connecting with the external power source device so as to transmit external mechanical energy into rotational energy for inducing the electrical current at the stationary armature devices 20. For longer construction of the stacking alternator of the present invention, more than one rotating magnetic devices 30, such as the two end pieces rotating magnetic devices 30′, are driven by the pulley system 40 to rotate simultaneously. It is apparent that the supporting frame 10 may further include a stand to lift or support the weight of the whole stacking alternator.

Each of the stationary armature devices 20 has a plurality of armature coils 22 stacking radically to form a ring shape, as shown in FIGS. 3B and 3C. According to the preferred embodiment of the present invention, it is arranged to that three armature coils 22 are slantedly overlapped and aligned with each of the corresponding magnetic members 32.

It is embodied to have eighteen magnetic members 32 for each of the rotating magnetic device 30 and each stationary armature device 20 is embodied to have 54 armature coils slantedly stacking to form 3 layers that each layer has 18 armature coils matching with the 18 permanent magnetic members 32, as shown in FIG. 3C. Therefore, each magnetic member 32 is arranged to have 54 armature coils 22 laid thereabove and each magnetic member 32 is matched with at least an armature coil 22 anytime during the rotation of the respective rotating magnetic device 30.

The number of magnetic members 32 determines the RPM rated speed of the rotating magnetic device 30. The armature coils 22 can be put in a series or parallel combination and then they are set in a holder (e.g. epoxy layer 24) so the armature coils 22 cannot move and are pressed down so that they lay as flat as possible, wherein powder can be used to make it easier for the armature coils 22 to be released from its form.

Referring to FIGS. 3A to FIG. 3C of the drawings, each of the armature coils 22 is repetitively wound to form a quadrilateral loop, wherein three of such quadrilateral loops are stacked in a predetermined manner to form one armature coil set 221 of three layers of armature coils 22.

According to the preferred embodiment of the present invention, the inner side of each loop of each armature coil 22 is preferred to be slightly shorter than the outer side thereof. In addition, each three of the quadrilateral loops are overlappedly stacked in such a manner that an upper quadrilateral loop formed by the corresponding armature coil 22 is overlapped on a lower quadrilateral loop at a position slightly offset (i.e. sidewardly moved) from the lower quadrilateral loop.

In other words, an upper quadrilateral loop does not align with the lower quadrilateral loop so that another set of armature coil set 221 can be positioned side-by-side with an adjacent armature coil set 221, wherein the armature coil sets 221 of the stationary armature device 20 are arranged in a shape (substantially circular in this preferred embodiment) which corresponds with the cross sectional shape of the corresponding rotating magnetic device 30.

Therefore, according to the preferred embodiment of the present invention, for each of the magnetic members 32, there are three armature coil sets 221 arranged thereabove. Since the rotating magnetic device 30 has eighteen magnetic members 32, there should be fifty four armature coil sets 221 formed in the stationary armature device 20. It is worth mentioning that when the armature coils 22 are properly stacked as mentioned above, the armature coil sets 221 are arranged to embed in the epoxy layer 24 for imparting a rigidity of the stationary armature device 20.

The operation of the present invention is described as follows. Depending on the energy need in a particular circumstance, an operator may determine the number of rotating magnetic devices 30 and the stationary armature devices 20 to be used for generating electricity. The desirable number of rotating magnetic devices 30 and the stationary armature devices 20 are then connected in a stacking manner as described above, wherein the rotating magnetic devices 30 are arranged to be connected to an external power source device (for example through the pulley system 40) for being driven to produce the relative movement between the stationary armature devices 20 and the rotating magnetic devices 30. When the external power source device drives the rotating magnetic devices 30 to rotate, the magnetic members 32 are also driven to rotate as well so as to produce the relative movement between the rotating magnetic devices 30 and the stationary armature devices 20. The relative movement produces induced e.m.f. at the stationary armature devices 20 which are then electrically connected to power collection device for collection of an overall output current of the stacking alternator of the prevent invention.

There are several other distinctive features of the present invention with respect to the conventional arts. First, the relative movement between the rotating magnetic devices 30 and the stationary armature devices 20 is accomplished by rotating the rotating magnetic devices so that no brush is necessary for the alternator. As a result, the traditional mechanical problems associated with brushes in traditional alternator can be avoided.

Second, a relative low revolution on the part of the rotating magnetic devices 30 can produce a relatively high current output. Thus, the rotating magnetic devices 30 and the stationary armature devices 20 are supported in stack for generating a relatively large amount of electrical current with a relatively compact size of the stacking alternator.

Third, since the stacking alternator of the present invention does not involve the use of brushes, the speed of rotation on the part of the rotating magnetic devices 30 can be substantially increased so as to increase the rate of change of magnetic flux between the rotating magnetic devices 30 and the stationary armature devices 20. As such, the effectiveness and efficiency of the performance of the stacking alternator are also enhanced as compared with conventional alternators.

Fourth, the stationary armature devices 20 and the rotating magnetic devices 30 can be selectively assembled and disassembled for allowing the stacking alternator to be utilized in a wide variety of circumstances depending on specific needs. In other words, when different power needs are required, users of the present invention may simply utilize the corresponding number of stationary armature devices 20 and the rotating magnetic devices 30 without substantially altering the structure of the alternator.

Fifth, rotation of the rotating magnetic devices 30 can be stopped relatively easily and rapidly without any adverse effect on the part of the stationary armature devices 20 because there is no brush involved in the stacking alternator.

It is worth to mention that stacking alternator of the present invention can be incorporated or electrically connected with an electrical rectifier 50 for producing a desired type of output current. Accordingly, each of the stationary armature devices 20 further comprises an extension coil 23 extended from the armature coils 22 current to be transformed to a DC output, wherein the supporting shaft 11 is a hollow shaft that enables the extension coils of the stationary armature devices 20 extending axially through the hollow supporting shaft 11 to one end thereof to electrically connected with the electrical rectifier 50, as shown in FIGS. 1 and 2.

Alternatively, the extension coils 23 can also be electrically connected to other electrical components for collecting AC current output directly from the stacking alternator. As a result, the electrical rectifier 50 is arranged to rectify the AC output to a DC output of a desirable voltage.

It is also worth mentioning that the extension coils 23 extended from the stationary armature devices 20 can be electrically connected in a predetermined electrical pattern (such as in parallel or in series) so as to achieve a desirable voltage or current output. The rectified current is then ready for further transmission. For example, when an overall high voltage of the stacking alternator is required, a series arrangement of the extension coils 23 with the stationary armature devices 20 can be established. Similarly, when an overall high current of the stacking alternator is required, the extension coils 23 can be connected in parallel with the stationary armature devices 20.

In order to ensure proper electromagnetic induction at the stationary armature devices 20 and proper operation of the present invention, the supporting frame 10 further comprises the plurality of spacers 60 provided at a peripheral rim portion of each of the stationary armature devices 20 for maintaining a predetermined gap between the stationary armature devices 20 and adjacent rotating magnetic devices 30. More specifically, each of the spacers 60 has a height which is greater than a depth of the corresponding stationary armature device 20 so as to maintain a predetermined gap or space between the stationary armature device 20 and adjacent rotating magnetic devices 30.

As shown in FIG. 5 of the drawings, the present invention also provides a method of generating electricity using a stacking alternator, comprising the steps of:

(a) providing at least two rotating magnetic devices 20 and at least a stationary armature device 30, wherein the stationary armature device 20 is securely and spacedly supported by a supporting frame, and the rotating magnetic devices 30 are rotatably supported by the supporting frame 10 at a position between the two stationary armature devices 20;

(b) driving the rotating magnetic devices 30 to rotate with respective to the stationary armature device so as to produce a relative movement between the stationary armature device 20 and the rotating magnetic devices 30 for generating a predetermined amount of electrical current at the stationary armature device 20, wherein stationary armature device 20 and the rotating magnetic devices 30 are alignedly and spacedly supported by the supporting frame 10 to form a stacking structure of the stationary armature device 20 and the rotating magnetic devices 30; and

(c) processing the current output from each of the stationary armature device 20 for further transmission.

Step (c) comprises the steps of:

(c.1) electrically connecting the extension coil 23 of the stationary armature device 20 in a predetermined electrical pattern (such as in parallel or in series) so as to optimally obtain a desired overall output voltage or a desired overall output current of the stacking alternator;

(c.2) rectifying the overall output current of the extension coil 23 of the stationary armature device 20 by an electrical rectifier 50, wherein the rectified current is then transmitted for future use.

The method also comprises a step of providing a plurality of rotating magnetic devices 30 and stationary armature devices 20, wherein each additional stationary armature device 20 and each additional rotating magnetic device 30 are supported by said supporting frame 10, wherein each of said stationary armature devices 20 is arranged to be sandwiched by two rotating rotating magnetic devices 30 so that when said rotating magnetic devices 30 are driven to rotate, electrical current is induced at said corresponding stationary armature devices 20.

Moreover, as mentioned earlier, the method further comprises a step of providing a plurality of spacers 60 each having a height which is greater than a depth of the corresponding stationary armature device 20 for maintaining a predetermined gap or space between the corresponding stationary armature devices 20 and the adjacent rotating magnetic devices 30.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A stacking alternator, comprising:
a supporting frame;
at least one stationary armature device securely supported by said supporting frame; and
at least two rotating magnetic devices rotatably supported by said supporting frame at two sides of said stationary armature device respectively, wherein said rotating magnetic devices are arranged to be driven to move with respective to said stationary armature device so as to produce a relative movement between said stationary armature device and said rotating magnetic devices for generating a predetermined amount of electrical current at said stationary armature device, wherein said stationary armature device and said rotating magnetic devices are alignedly and spacedly supported by said supporting frame to form a stacking structure of said stationary armature device and said rotating magnetic devices.

2. The stacking alternator, as recited in claim 1, wherein said stationary armature device comprises a plurality of armature coils repetitively wound to form a quadrilateral loop, wherein three of said quadrilateral loops are stacked to form an armature coil set, wherein said quadrilateral loops of each of said armature coil sets are overlappedly stacked in such a manner that an upper quadrilateral loop is overlapped on a lower quadrilateral loop at a position slightly offset from said lower quadrilateral loop so that another set of armature coil set is capable of being positioned side-by-side with an adjacent armature coil set.

3. The stacking alternator, as recited in claim 2, wherein each of said rotating magnetic devices comprises a rotor frame and a plurality of permanent magnetic members spacedly provided on said rotor frame for providing a predetermined magnetic field for said corresponding stationary armature devices, wherein said rotor frame has a substantially circular cross section and a plurality receiving slots spacedly provided thereon for said magnetic members to be securely mounted at said receiving slots respectively for proving said magnetic field to generate said electrical current at said stationary armature device.

4. The stacking alternator, as recited in claim 3, wherein said rotor frame has a central portion having a rotor slot formed thereon, an outer peripheral rim portion, and a plurality of connecting members radially and spacedly extended from said central portion to said outer peripheral rim portion along a circumferential length thereof to define a corresponding number of said receiving slots between each two of said connecting members, wherein said supporting shaft of said supporting frame is arranged to engage with said rotor slot for producing said relative movement between said rotating magnetic device and said stationary armature devices.

5. The stacking alternator, as recited in claim 2, further comprising an electrical rectifier for producing a desired type of overall output current, wherein said stationary armature device further comprises an extension coil extended from said armature coils to said electrical rectifier for allowing said induced current to be selectively transformed to a DC output of a desirable voltage and current.

6. The stacking alternator, as recited in claim 4, further comprising an electrical rectifier for producing a desired type of overall output current, wherein said stationary armature device further comprises an extension coil extended from said armature coils to said electrical rectifier for allowing said induced current to be selectively transformed to a DC output of a desirable voltage and current.

7. The stacking alternator, as recited in claim 1, further comprising a plurality of spacers each having a height which is greater than a depth of said corresponding stationary armature device so as to maintain a predetermined gap or space between said corresponding stationary armature device and said adjacent rotating magnetic devices.

8. The stacking alternator, as recited in claim 4, further comprising a plurality of spacers each having a height which is greater than a depth of said corresponding stationary armature device so as to maintain a predetermined gap or space between said corresponding stationary armature device and said adjacent rotating magnetic devices.

9. The stacking alternator, as recited in claim 6, further comprising a plurality of spacers each having a height which is greater than a depth of said corresponding stationary armature device so as to maintain a predetermined gap or space between said corresponding stationary armature device and said adjacent rotating magnetic devices.

10. The stacking alternator, as recited in claim 1, further comprising a plurality of rotating magnetic devices and stationary armature devices, wherein each additional rotating magnetic device and each additional stationary armature device are supported by said supporting frame, wherein each of said stationary armature device is arranged to be supported between two rotating and adjacent rotating magnetic devices so that when said rotating magnetic devices are driven to rotate, electrical current is induced at said corresponding stationary armature devices.

11. The stacking alternator, as recited in claim 6, further comprising a plurality of rotating magnetic devices and stationary armature devices, wherein each additional rotating magnetic device and each additional stationary armature device are supported by said supporting frame, wherein each of said stationary armature device is arranged to be supported between two rotating and adjacent rotating magnetic devices so that when said rotating magnetic devices are driven to rotate, electrical current is induced at said corresponding stationary armature devices.

12. The stacking alternator, as recited in claim 9, further comprising a plurality of rotating magnetic devices and stationary armature devices, wherein each additional rotating magnetic device and each additional stationary armature device are supported by said supporting frame, wherein each of said stationary armature device is arranged to be supported between two rotating and adjacent rotating magnetic devices so that when said rotating magnetic devices are driven to rotate, electrical current is induced at said corresponding stationary armature devices.

13. A method of generating electricity, comprising the steps of:
(a) providing at least one stationary armature device, two rotating magnetic devices and a supporting frame, wherein said stationary armature device is securely and spacedly supported by said supporting frame, and said rotating magnetic devices are rotatably supported by said supporting frame at two sides of said stationary armature device respectively;
(b) driving said rotating magnetic devices to rotate with respective to said stationary armature device so as to produce a relative movement between said stationary armature device and said rotating magnetic devices for generating a predetermined amount of electrical current at said stationary armature device, wherein said stationary armature device and said rotating magnetic devices are alignedly and spacedly supported by said supporting frame to form a stacking structure of said stationary armature device and said rotating magnetic devices; and
(c) processing said electrical current outputted from said stationary armature device by an electrical rectifier for further electrical transmission.

14. The method, as recited in claim 13, further comprising a step of providing a plurality of rotating magnetic devices and stationary armature devices, wherein each additional rotating magnetic device and each additional stationary armature device are supported by said supporting frame, wherein each of said stationary armature devices is arranged to be rotatably sandwiched between two of said adjacent and rotating rotating magnetic devices so that when said rotating magnetic devices are driven to rotate, electrical current is induced at said corresponding stationary armature devices.

15. The method, as recited in claim 14, wherein said step (c) comprises the steps of:
(c.1) electrically connecting each of the stationary armature devices in a predetermined electrical pattern so as to optimally obtain a desired overall output voltage and a desired overall output current for said stacking alternator; and
(c.2) rectifying said overall output current of said stationary armature devices by an electrical rectifier, wherein a rectified current is then transmitted for further use.

16. The method, as recite in claim 14, wherein each of said stationary armature devices comprises an extension coil extended from said armature coils to said electrical rectifier for allowing said induced current to be selectively transformed to a DC output of a desirable voltage and current.

17. The method, as recite in claim 15, wherein each of said stationary armature devices comprises an extension coil extended from said armature coils to said electrical rectifier for allowing said induced current to be selectively transformed to a DC output of a desirable voltage and current.

18. The method, as recited in claim 15, further comprising a step of providing a plurality of spacers each having a height which is greater than a depth of said corresponding stationary armature device for maintaining a predetermined gap or space between said corresponding stationary armature device and said adjacent rotating magnetic devices.

19. The method, as recited in claim 16, further comprising a step of providing a plurality of spacers each having a height which is greater than a depth of said corresponding stationary armature device for maintaining a predetermined gap or space between said corresponding stationary armature device and said adjacent rotating magnetic devices.

20. The method, as recited in claim 17, further comprising a step of providing a plurality of spacers each having a height which is greater than a depth of said corresponding stationary armature device for maintaining a predetermined gap or space between said corresponding stationary armature device and said adjacent rotating magnetic devices.
